(19) United States
(12) Patent Application Publication
(10) Pub. No.: US 2023/0366364 A1
(43) Pub. Date: Nov. 16, 2023

(54) THRUST-REVERSAL SYSTEM FOR AN AIRCRAFT AND AIRCRAFT INCLUDING SUCH A SYSTEM

(71) Applicant: SAFRAN NACELLES, Gonfreville-L'Orcher (FR)

(72) Inventors: Hakim MAALIOUNE, Moissy-Cramayel (FR); Matthieu LEROUVREUR, Moissy-Cramayel (FR); Vincent Jean-Francois PEYRON, Moissy-Cramayel (FR)

(21) Appl. No.: 18/246,395

(22) PCT Filed: Oct. 13, 2021
(86) PCT No.: PCT/FR2021/051774

§ 371 Date: Mar. 23, 2023

(30) Foreign Application Priority Data
Oct. 13, 2020 (FR) 2010454

(51) Int. Cl. F02K 1/76

(52) U.S. Cl. CPC F02K 1/763; F02K 1/766; F05D 2270/52; F05D 2270/62

(57) ABSTRACT

A thrust-reversal cowling selectively movable between a retracted position for leaving unchanged the thrust of an aircraft turbine engine, and a deployed position for reversing the thrust of the turbine engine; an electrical actuator of the cowling; a local control module to receive commands from a global control module to control the electrical actuator to move the cowling, these commands including a retraction command and a deployment command; and a connection between the global control module and the local control module for conveying at least one analogue signal. The local control module identifies one among a plurality of predefined ranges of values, in which each analogue signal is located at a given instant, each command being associated with one or more value ranges; and determining the received command as being that associated with the identified range or ranges of values.

The present invention relates to a thrust-reversal system for an aircraft and an aircraft comprising such a system.

The aircraft A380 and the aircraft C919 each comprise a thrust-reversal system, of the type comprising:
a thrust-reversal cover designed to be selectively moved between a stowed position for leaving unchanged the thrust of a turbine engine of the aircraft and a deployed position for reversing the thrust of the turbine engine;
an electric actuator for the cover;
a local command module designed to receive commands from a global command module in order to control the electric actuator in such a way as to move the cover, these commands including:
   a stow command to move the cover to its stowed position, and
   a deploy command to move the cover to its deployed position; and
a connection between the global command module and the local command module for conveying at least one analogue signal.

The global command module is usually referred to as EEC (Engine Electronic Control), while the local command module is usually referred to as ETRAS (Electrical Thrust Reverser Actuation System). Furthermore, in these aircrafts, the connection between the global command module EEC and the local command module ETRAS is a digital bus, in particular according to ARINC 429.

According to this standard, the data exchanged is coded as 32-bit words divided into several distinct fields.

According to this standard, the digital bus comprises a pair of twisted wires and the bits are sequentially transmitted as an analogue voltage signal between the two wires, each bit having a high value when the bit is 1 and a low value when the bit is 0.

Thus, the implementation of this standard requires complex components in both the global command module EEC to encode the commands as 32-bit words and in the local command module ETRAS to decode the received 32-bit words and derive the commands.

It may therefore be desirable to provide a thrust-reversal system that enables at least a portion of the above problems and constraints to be overcome.

A thrust-reversal system of the above type is therefore proposed, characterised in that the local command module is designed to:
identify one among several predefined ranges of values in which each analogue signal is located at a given instant, each command being associated with one or more of the ranges of values; and
determine the received command as being associated with the identified range or ranges of values.

With the invention, simple components can be used in the local command module. Thus, the local command module is simplified with respect to the one required with an ARINC 42 connection.

Optionally, the connection comprises two electrical connectors conveying two respective analogue voltage signals, each associated with two ranges of values, each command being associated with a respective one of predefined combinations of the ranges of values for the two electrical connectors.

Optionally also, the connection comprises an electrical connector conveying an analogue current signal associated with several ranges of values, each command being associated with a respective one of the ranges of values.

Optionally also, the local command module comprises an analogue to digital converter designed to convert the analogue signal(s) into digital data and a digital module designed to process this digital data to determine the commands and control the electric actuator.

Optionally also, the local command module comprises an analogue circuit designed to process the analogue signal(s) to determine the commands and control the electric actuator.

Optionally also, the electric actuator comprises an electric motor for moving the cover and an inverter designed to electrically activate the electric motor from a direct current voltage bus and the local command module is designed to control the inverter.

Optionally also, the thrust-reversal system further comprises a lock system referred to as primary lock system designed to selectively lock and unlock the electric motor of the electric actuator of the thrust-reversal cover and the local command module is designed to:
on receipt of the deploy command, to control the primary lock system to unlock the electric motor of the electric actuator of the thrust-reversal cover from the electric actuator of the thrust-reversal cover, before the cover has been moved to its deployed position; and
on receipt of the stow command, to control the primary lock system to lock the electric motor of the electric actuator of the thrust-reversal cover, after the cover has been moved to its stowed position.

Optionally also, the thrust-reversal system further comprises a lock system referred to as tertiary lock system designed to selectively lock and unlock the cover, the cover is further designed to be selectively moved into an overstowed position facilitating unlocking of the cover by the tertiary lock system, the commands include an overstow command and the local command module is designed, upon receipt of the overstow command, to control the primary lock system to unlock the electric motor of the electric actuator of the thrust-reversal cover prior to controlling the inverter so that the cover is moved to its overstowing position.

An aircraft is also proposed with:
a turbine engine; and
a thrust-reversal system according to the invention.

The invention will be better understood with the aid of the following description, given only by way of example and made with reference to the attached drawings in which:

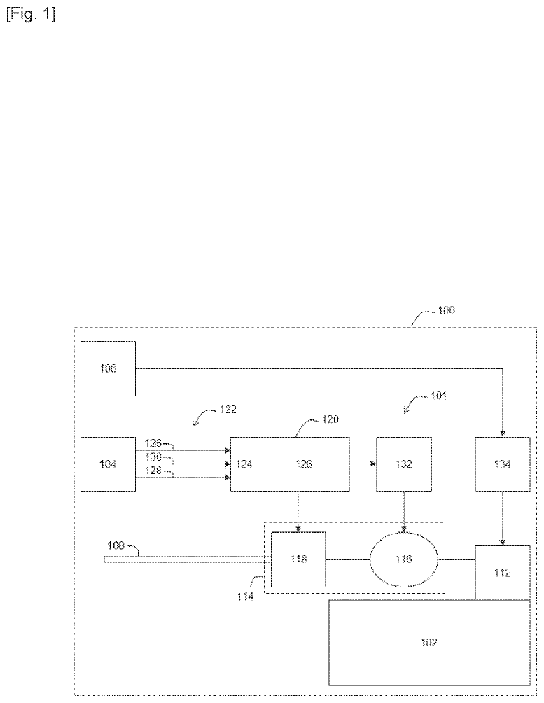

FIG. 1 is a simplified view of an aircraft with a thrust-reversal system according to a first embodiment of the invention,

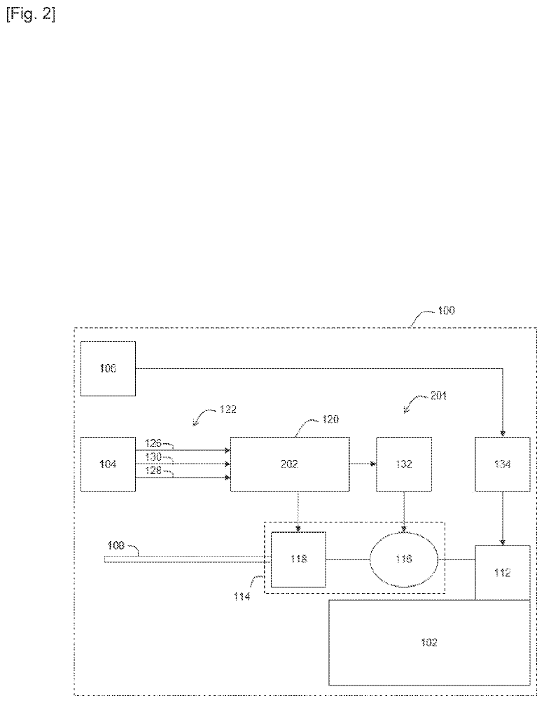

FIG. 2 is a simplified view of an aircraft comprising a thrust-reversal system according to a first embodiment of the invention, and

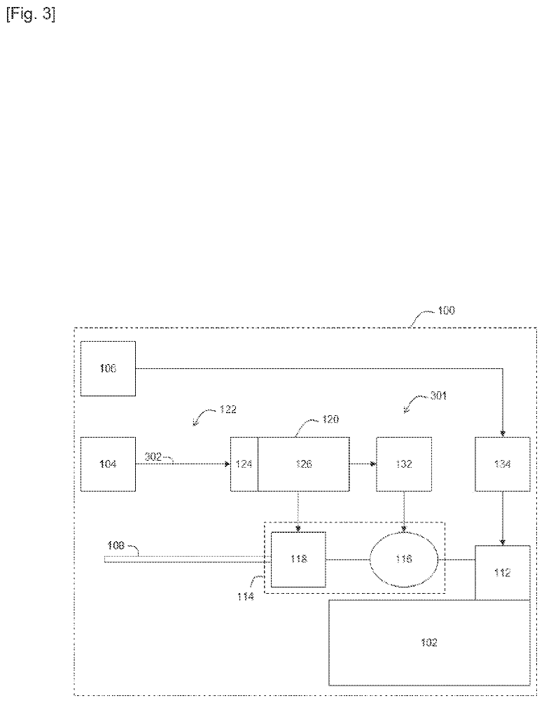

FIG. 3 is a simplified view of an aircraft comprising a thrust-reversal system according to a first embodiment of the invention.

With reference to FIG. 1, an aircraft 100 comprising a thrust-reversal system 101 according to a first embodiment of the invention will now be described.

The aircraft 100 firstly comprises a turbine engine 102.

The aircraft 100 further comprises a global command module 104, such as an EEC.

The aircraft 100 further comprises various members, grouped under reference 106, other than the aircraft engine, for example aircraft computers, aircraft power supplies, etc.

The aircraft 100 further comprises a direct current voltage bus 108.

The thrust-reversal system 101 firstly comprises a thrust-reversal cover 112 designed to be selectively moved between a stowed position to leave the thrust of the turbine engine 102 unchanged and a deployed position to reverse the thrust of the turbine engine 102.

The system 101 further comprises an electric actuator 114 of the cover 112.

In the example described, the electric actuator 114 comprises an electric motor 116 for moving the cover 112 and an inverter 118 designed to electrically activate the electric motor 116 from the direct current voltage bus 108.

The system 101 further comprises a local command module 120, such as an ETRAS.

The system 101 further comprises a connection 122 between the global command module 104 and the local command module 120. This connection 122 is designed for conveying at least one analogue signal from the global command module 104 and the local command module 120. This analogue signal(s) represents commands for the local command module 120.

In the example described, the connection 122 comprises three electrical conductors 124, 126 and 128. The first two electrical conductors 124, 126 are intended to convey respectively two analogue voltage signals V1, V2, referenced to the third electrical conductor 128 forming an electrical ground.

Also, in the example described, the local command module 120 comprises an analogue to digital converter 124 designed to convert the analogue signal(s) (the voltages V1, V2 in the example described) into digital data and a digital module 126 designed to process this digital data to determine the commands received.

The commands include in particular: a stow command to move the cover 112 to its stowed position and a deploy command to move the cover 112 to its deployed position.

Furthermore, in the example described, the system 101 comprises several lock systems to prevent an untimely deployment of the cover 112, for example outside the landing phase of the aircraft 100.

Thus, the system 101 further comprises a lock system referred to as primary lock system 132 designed to selectively lock (e.g. by mechanical locking) and unlock the electric motor 116 of the electric actuator 114 of the thrust-reversal cover 112. In this case, the local command module 120 is designed to, upon receipt of the deploy command, control the primary lock system 132 to unlock the electric motor 116 of the electric actuator 114 of the thrust-reversal cover 112, before the cover 112 has been moved to its deployed position. It is further adapted to, upon receipt of the stow command, control the primary lock system 132 to lock the electric motor 116 of the electric actuator 114 of the thrust-reversal cover 112, after the cover 112 has been moved to its stowed position.

Typically, two thrust-reversal systems such as 101 are provided, with the covers linked to each other. Thus, the primary lock system of one system forms a lock system referred to as secondary lock system for the other system.

The system 101 further comprises a tertiary lock system 134 designed to selectively lock and unlock the cover 112. In this case, the cover 112 is preferably further designed to be selectively moved into a overstowed position facilitating unlocking of the cover by the tertiary lock system 134. This overstowed position is usually an even more stowed position. The commands then further comprise an overstow command and the local command module 120 is then designed to, on receipt of the overstow command, control the primary lock system 132 to unlock the electric motor 116 from the electric actuator 114 of the thrust-reversal cover 112, prior to controlling the inverter 118 so that the cover 112 is moved to its overstowing position.

The tertiary lock system 134 is, for example, controlled by the members 106, for example by a lever provided in a cockpit of the aircraft 100 which activates the closing of a relay. However, many other means of controlling the tertiary lock system 134 may be provided.

As previously explained, the local command module 120 is designed to receive commands from the global command module 104, via the connection 122, to control the electric actuator 114, and more specifically the inverter 118 in the example described, so as to move the cover 112.

In general, the local command module 120 is designed to identify one among a plurality of predefined ranges of values in which each analogue signal is located at a given instant, each command being associated with one or more of ranges of values. The local command module 120 is further designed to determine the received command as the one associated with the identified value range(s).

More specifically, in the example described, the analogue voltage signals V1, V2 are each associated with two ranges of values. For example, one of these two value ranges extends around zero voltage, and the other value range extends around 28 V. Each command is associated with a respective one of the predefined combinations of the value ranges of the two analogue voltage signals V1, V2. Thus, it can be considered that the commands are coded on three bits [b1 b2 b3] respectively transmitted by the three electrical conductors 126, 130, 128. The first bit b1 is transmitted by the first electrical conductor 126 and its values correspond to the two value ranges for this first electrical conductor 126. The second bit b2 is transmitted by the third electrical conductor 130 which is not intended to transmit an analogue signal so that the second bit b2 remains at the same value, for example zero. The third bit b3 is transmitted by the second electrical conductor 128 and its values correspond to the two value ranges for this second electrical conductor 128.

Thus, in the example described, the commands are coded by the bits [b1 b2 b3] as follows:

TABLE 1

| [b1 b2 b3] | Command |
|---|---|
| [0 0 0] | No command |
| [1 0 1] | OVERSTOW |
| [1 0 1] | DEPLOY |
| [1 0 0] | STOW |

Thus, in the example described, the OVERSTOW and DEPLOY commands have the same code. In this case, for example, upon receipt of this code, the OVERSTOW command can be performed, and then after a certain delay time (implemented for example by a delay device) the DEPLOY command can be automatically performed, without requiring the receipt of a new code. Alternatively, two different codes could be associated with the OVERSTOW and DEPLOY commands respectively, each of which is performed upon receipt of its associated code.

With reference to FIG. 2, a thrust-reversal system 201 according to a second embodiment of the invention will now be described. The system 201 is similar to that of FIG. 1, except that the local command module 120 comprises, instead of 124 and 126, an analogue circuit 202 for deriving the commands and commanding the inverter 118 accordingly.

With reference to FIG. 3, a thrust-reversal system 301 according to a third embodiment of the invention will now be described. The system 301 is similar to that of FIG. 1, except that the connection 122 comprises an electrical connector 304 conveying an analogue current signal associated with a plurality of value ranges, each command being associated with a respective one of the value ranges. Preferably, the ranges of values do not overlap in order to avoid command banding. Preferably, the ranges of values are disjoint, except possibly between the respective ranges of the OVERTOW and DEPLOY commands.

In the example described, the commands are coded as follows:

TABLE 2

| Current value range | Command |
|---|---|
| [value 1-value 2] | OVERSTOW |
| [value 2-value 3] | DEPLOY |
| [value 4-value 5] | STOW |

The values outside these command ranges are considered invalid.

It is clear that a thrust-reversal system such as those described above allows the use of simple components.

It will be further noted that the invention is not limited to the embodiments described above. It will indeed appear to the person skilled in the art that various modifications can be made to the above-described embodiments, in the light of the teaching just disclosed.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. A thrust-reversal system for an aircraft, comprising:
a thrust-reversal cover designed to be selectively moved between a stowed position for leaving unchanged the thrust of a turbine engine of the aircraft, and a deployed position for reversing the thrust of the turbine engine;
an electric actuator of the cover;
a local command module designed to receive commands from a global command module in order to control the electric actuator in such a way as to move the cover, these commands including:
a stow command to move the cover to its stowed position, and
a deploy command to move the cover to its deployed position; and
a connection between the global command module and the local command module (120) for conveying at least one analogue signal;
wherein the local command module is designed to:
identify one among several predefined ranges of values in which each analogue signal is located at a given instant, each command being associated with one or more of the ranges of values; and
determine the received command as being associated with the identified range or ranges of values.

2. The thrust-reversal system according to claim 1, wherein the connection comprises two electrical connectors conveying respectively two analogue voltage signals, each associated with two ranges of values, each command being associated with a respective one of predefined combinations of the ranges of values for the two electrical connectors.

3. The thrust-reversal system according to claim 1, wherein the connection comprises an electrical connector conveying an analogue current signal associated with several ranges of values, each command being associated with a respective one of the ranges of values.

4. The thrust-reversal system according to claim 1, wherein the local command module comprises an analogue to digital converter designed to convert the analogue signal(s) to digital data and a digital module designed to process that digital data to determine the commands and control the electric actuator.

5. The thrust-reversal system according to claim 1, wherein the local command module comprises an analogue circuit designed to process the analogue signal(s) to determine commands and control the electric actuator.

6. The thrust-reversal system according to claim 1, wherein the electric actuator comprises an electric motor for moving the cover and an inverter designed to electrically activate the electric motor from a direct current voltage bus and wherein the local command module is designed to control the inverter.

7. The thrust-reversal system according to claim 6, further comprising a lock system referred to as primary lock system designed to selectively lock and unlock the electric motor of the electric actuator of the thrust-reversal cover and wherein the local command module is designed:
on receipt of the deploy command, to control the primary lock system to unlock the electric motor of the electric actuator of the thrust-reversal cover of the electric actuator of the thrust-reversal cover before the cover has been moved to its deployed position; and
on receipt of the stow command, to control the primary lock system to lock the electric motor of the electric actuator of the thrust-reversal cover, after the cover has been moved to its stowed position.

8. The thrust-reversal system according to claim 6, further comprising a lock system referred to as tertiary lock system designed to selectively lock and unlock the cover, wherein the cover is further designed to be selectively moved to an overstowed position facilitating an unlocking of the cover by the tertiary lock system wherein the commands include a overstow command and wherein the local command module is designed, upon receipt of the overstow command, to control the primary lock system to unlock the electric motor of the electric actuator of the thrust-reversal cover prior to controlling the inverter so that the cover is moved to its overstowing position.

9. An aircraft comprising:
a turbine engine; and
the thrust-reversal system according to claim 1.
